(19) United States
(12) Patent Application Publication
(10) Pub. No.: US 2004/0257388 A1
(43) Pub. Date: Dec. 23, 2004

(54) Image display having pixel array

(75) Inventor: Youichi Tobita, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Denki Kabushiki Kaisha, TOKYO (JP)

(21) Appl. No.: 10/849,042

(22) Filed: May 20, 2004

(30) Foreign Application Priority Data
Jun. 17, 2003 (JP) 2003-172157

(51) Int. Cl. G09G 5/10

(52) U.S. Cl. 345/690

(57) ABSTRACT

In the color liquid crystal display, an insulating substrate having an analog amplifier which is likely to suffer failure formed thereon, and an insulating substrate having a circuit portion other than the analog amplifier formed thereon are separately prepared and quality-tested, and only the insulating substrate of good quality is mounted on the insulating substrate of good quality. This can increase yield of the color liquid crystal display compared to the conventional case where the entire color liquid crystal display is formed on a single insulating substrate.

### BACKGROUND OF THE INVENTION

1. Field of the Invention

The present invention relates to an image display. More particularly, the present invention relates to an image display having a pixel array which includes a plurality of pixel display circuits arranged in rows and columns.

2. Description of the Background Art

A conventional liquid crystal display is formed on a single insulating substrate and includes a pixel array having a plurality of pixels arranged in a plurality of rows and a plurality of columns, a plurality of gate lines provided corresponding to the plurality of rows, respectively, and a plurality of data lines provided corresponding to the plurality of columns, respectively, a vertical scan circuit which sequentially selects the plurality of gate lines, one for each horizontal scanning period, and a horizontal scan circuit which provides a gradation potential to each of the data lines during each horizontal scanning period (see Japanese Patent Laying-Open No. 2000-338521, for example).

With the conventional liquid crystal display, however, the yield thereof remains low because properties of the transistors therein vary widely.

### SUMMARY OF THE INVENTION

Therefore, a main object of the present invention is to provide an image display achieving high yield.

An image display according to the present invention includes: a pixel array having a plurality of pixel display circuits arranged in a plurality of rows and a plurality of columns and each displaying a pixel with a gradation corresponding to a pixel potential, a plurality of gate lines provided corresponding to the plurality of rows, respectively, and a plurality of data lines provided corresponding to the plurality of columns, respectively; a vertical scan circuit sequentially selecting the plurality of gate lines, one for each predetermined period of time, and activating each of the pixel display circuits corresponding to the selected gate line; a horizontal scan circuit providing, while the vertical scan circuit selects one gate line, the pixel potential to each of the activated pixel display circuits through the plurality of data lines; an insulating substrate having at least the pixel array formed on a surface thereof; and at least one sub-insulating substrate mounted on the surface of the insulating substrate. The vertical scan circuit and the horizontal scan circuit are located on the surface of the insulating substrate and the surface of at least one sub-insulating substrate, separately. A circuit portion of the horizontal scan circuit connected to at least the plurality of data lines is formed on the surface of at least one sub-insulating substrate.

Therefore, the sub-insulating substrate on which the circuit portion of the horizontal scan circuit connected to at least the plurality of data lines is formed and the insulating substrate on which at least the pixel array is formed are separately prepared and quality-tested, and only a sub-insulating substrate of good quality is mounted on an insulating substrate of good quality. This allows yield improvement and cost reduction of the image display.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram functionally illustrating a configuration of a color liquid crystal display according to a first embodiment of the present invention.

FIG. 2 is a circuit diagram illustrating a configuration of a color pixel shown in FIG. 1.

FIG. 3 is a block diagram illustrating an actual configuration of the color liquid crystal display shown in FIG. 1.

FIGS. 4A and 4B illustrate a substrate mounting region and a surface of an insulating substrate 31 shown in FIG. 3, respectively.

FIG. 5 is a cross sectional view illustrating how insulating substrate 31 is mounted.

FIG. 6 is another cross sectional view illustrating how insulating substrate 31 is mounted.

FIGS. 7A and 7B are block diagrams showing a modification of the first embodiment.

FIG. 8 is a block diagram illustrating an actual configuration of the color liquid crystal display according to a second embodiment of the present invention.

FIGS. 9A and 9B illustrate a substrate mounting region and a surface of an insulating substrate 50 shown in FIG. 8, respectively.

FIG. 10 is a block diagram showing a modification of the second embodiment.

FIG. 11 is a block diagram showing another modification of the second embodiment.

FIG. 12 is a block diagram showing still another modification of the second embodiment.

FIG. 13 is a block diagram functionally illustrating a configuration of a color image display according to a third embodiment of the present invention.

FIG. 14 is a circuit diagram illustrating a configuration of a sub-pixel included in a color pixel shown in FIG. 13.

### DESCRIPTION OF THE PREFERRED EMBODIMENTS

First Embodiment

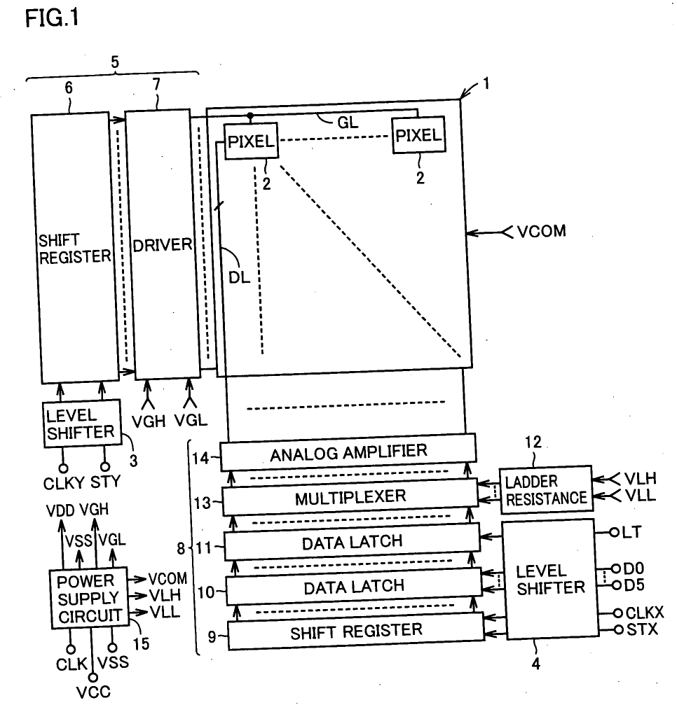

Referring to FIG. 1, the color liquid crystal display according to a first embodiment of the present invention includes a pixel array 1, level shifters 3 and 4, a vertical scan circuit 5, a horizontal scan circuit 8, and a power supply circuit 15.

Pixel array 1 includes a plurality of color pixels-2 arranged in a plurality of rows and a plurality of columns, a gate line GL provided corresponding to each of the rows, and three data lines DL for R, G and B provided corresponding to each of the columns.

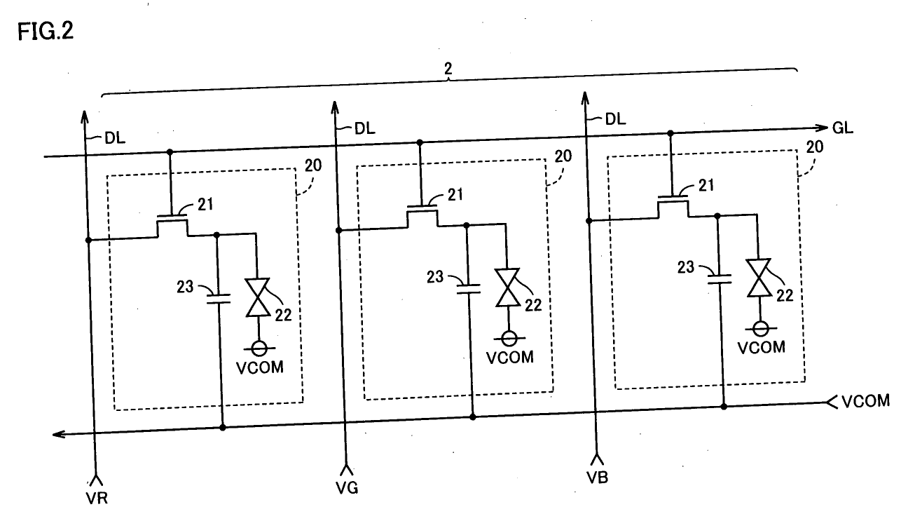

Referring to FIG. 2, color pixel 2 includes three sub-pixels 20 for R, G and B. These three sub-pixels 20 are provided with filters for R, G and B, respectively (not shown). Three data lines DL are provided with gradation potentials VR, VG and VB for R, G and B, respectively.

Sub-pixel 20 includes an N-type thin film transistor (TFT) 21, a liquid crystal cell 22 and a capacitor 23. N-type TFT 21 is connected between corresponding data line DL and a pixel electrode of liquid crystal cell 22 and has its gate connected to corresponding gate line GL. A counter electrode of liquid crystal cell 22 receives a common potential VCOM. Capacitor 23 is connected between the pixel electrode of liquid crystal cell 22 and a line of common potential VCOM.

When gate line GL is set to an “H” level of a selected level, N-type TFTs 21 are rendered conductive to charge the pixel electrodes of three liquid crystal cells 22 to gradation potentials VR, VG and VB for R, G and B, respectively. Light transmittance of liquid crystal cell 22 varies depending on a voltage between its electrodes. A pixel having desired color and luminance can be displayed by adjusting each level of gradation potentials VR, VG and VB.

Returning to FIG. 1, vertical scan circuit 5 includes a shift register 6 and a driver 7. Level shifter 3 converts each of the voltage amplitudes of a start signal STY and a clock signal CLKY provided externally from 3V to 5V, for example, and provides the converted start signal STY and clock signal CLKY to shift register 6. Shift register 6 sequentially selects the plurality of gate lines GL, one for each horizontal scanning period, in synchronization with start signal STY and clock signal CLKY. Driver 7 sets gate line GL selected by shift register 6 to an “H” level VGH of a selected level, and sets other gate lines GL to an “L” level VGL of a non-selected level.

Horizontal scan circuit 8 includes a shift register 9, data latches 10 and 11, a ladder resistance 12, a multiplexer 13, and an analog amplifier 14. Level shifter 4 converts each of the voltage amplitudes of a start signal STX, a clock signal CLKX, image data signals D0-D5, and a latch signal LT from 3V to 5V, for example. Shift register 9 controls data latch 10 in synchronization with start signal STX and clock signal CLKX from level shifter 4. Data latch 10 is controlled by shift register 9 to sequentially latch image data signals D0-D5 corresponding to one data line DL from level shifter 4 so as to latch image data signals D0-D5 corresponding to one row. Data latch 11 is controlled by latch signal LT from level sifter 4 to latch the relevant image data signals D0-D5 corresponding to one row and latched by data latch 10 at a time.

Ladder resistance 12 divides a voltage between a high potential VLH and a low potential VLL to produce 64 gradation potentials. Multiplexer 13 selects any of the 64 gradation potentials for each data line DL in accordance with image data signals D0-D5 received from data latch 11, and then provides the selected gradation potential to analog amplifier 14. Analog amplifier 14 in turn provides the gradation potential received from multiplexer 13 to each data line DL as VR, VG or VB. Sift register 9, data latches 10 and 11, ladder resistance 12 and multiplexer 13 constitute a D/A converter.

Power supply circuit 15 generates various internal power supply potentials VDD, VGH, VGL, VCOM, VLH and VLL based on a power supply potential VCC, a ground potential VSS and a clock signal CLK provided externally. Power supply circuit 15 includes a charge pump circuit driven by clock signal CLK. When vertical scan circuit 5 and horizontal scan circuit 8 scan all the pixels 2 in pixel array 1, a color image is displayed on pixel array 1.

Level shifters 3 and 4, vertical scan circuit 5, horizontal scan circuit 8, and power supply circuit 15 are each formed of a CMOS circuit including N-type and P-type TFTs. Horizontal scan circuit 8 herein adopts a line sequential driving system, and analog amplifier 14 thereof includes analog amplifier unit circuits of the same number as data lines DL. If horizontal scan circuit 8 adopts a dot sequential driving system, analog amplifier unit circuits smaller in number than data lines DL and a switching circuit are used. Each of the analog amplifier unit circuits has high input impedance and low output impedance, and outputs a potential equal to an input potential. When the same potential is input to all of the analog amplifier unit circuits, they ideally output the same potential. Actually, however, deviation occurs in output potentials among the analog amplifier unit circuits, because threshold voltages of TFTs and mobilities of majority carriers vary widely. When the deviation exceeds 30 mV, different colors are displayed at pixels even in the case where the same potential is input to all the analog amplifier unit circuits. Such a color liquid crystal display is considered defective.

A conventional color liquid crystal display is formed on a single insulating substrate. Therefore, even in the case where only analog amplifier 14 is found defective, the entire color liquid crystal display is considered defective, which results in low yield thereof. In contrast, in the first embodiment of the present invention, an insulating substrate 31 having analog amplifier 14 formed thereon, and an insulating substrate 30 having a circuit portion of the color liquid crystal display except for analog amplifier 14 formed thereon are separately prepared and quality-tested. Only insulating substrate 31 of good quality is then mounted on insulating substrate 30 of good quality so as to increase yield of the color liquid crystal display.

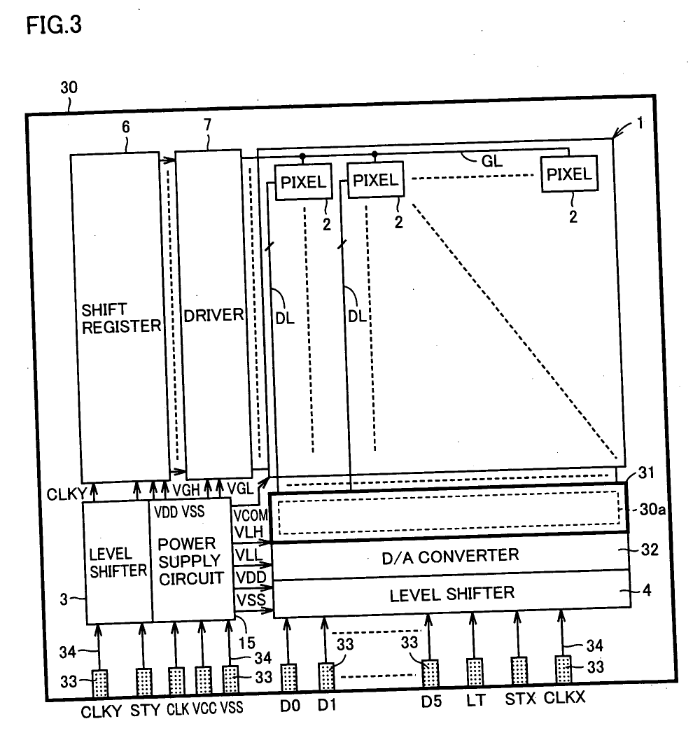

FIG. 3 shows an actual configuration of the color liquid crystal display. Referring to FIG. 3, pixel array 1 is located on a surface of insulating substrate 30 such as a glass substrate or a resin substrate. Driver 7 is located at one end of gate line GL. Shift register 6 is located adjacent to driver 7. At one end of data line DL, a substrate mounting region 30a is provided to mount insulating substrate 31 thereon. A D/A converter 32 is located adjacent to substrate mounting region 30a, and level shifter 4 is located adjacent to D/A converter 32. D/A converter 32 includes shift register 9, data latches 10 and 11, ladder resistance 12, and multiplexer 13 shown in FIG. 1. Power supply circuit 15 is located adjacent to driver 7 and substrate mounting region 30a, and level shifter 3 is located adjacent to shift register 6. The circuits on insulating substrates 30 and 31 is made of polysilicon.

A plurality of external terminals 33 are formed along one side of insulating substrate 30. Each external terminal 33 is connected to a corresponding circuit via an aluminum interconnection 34. The plurality of external terminals 33 are connected to a controller via a flexible printed circuit (FPC) and each external terminal 33 receives a signal or a potential from the controller. Two of the external terminals 33 which receive clock signal CLKY and start signal STY, respectively, are connected to level shifter 3. Three of the external terminals 33 which receive clock signal CLK, power supply potential VCC, and ground potential VSS, respectively, are connected to power supply circuit 15. Nine of the external terminals 33 which receive data signals D0-D5, latch signal LT, start signal STX and clock signal CLKX, respectively, are connected to level shifter 4.

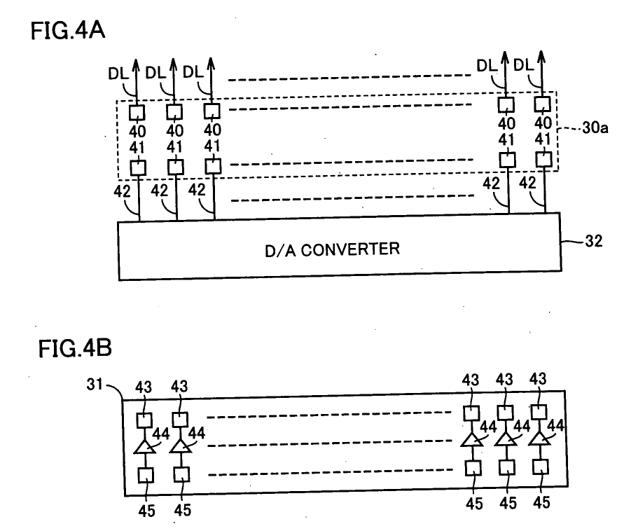

FIG. 4A illustrates substrate mounting region 30a, while FIG. 4B illustrates a surface of insulating substrate 31 (a surface facing the surface of insulating substrate 30). To simplify the drawings and the description, a pad and interconnection for power supply are not shown. Referring to FIGS. 4A and 4B, substrate mounting region 30a has formed therein an output pad 40 and an input pad 41 provided corresponding to each data line DL. A plurality of output pads 40 are arranged in line along a lower side of pixel array 1, and each output pad 40 is connected to corresponding data line DL. A plurality of input pads 41 are arranged in line along an upper side of D/A converter 32, with each input pad 41 being connected to D/A converter 32 via an aluminum interconnection 42.

On the surface of insulating substrate 31, there are formed an output pad 43, an analog amplifier unit circuit 44 and an input pad 45 provided corresponding to each data line DL. A plurality of output pads 43 are arranged in line along an upper side of insulating substrate 31 and each output pad 43 is connected to an output node of corresponding analog amplifier unit circuit 44. A plurality of input pads 45 are arranged in line along a lower side of insulating substrate 31 and each input pad 45 is connected to an input node of corresponding analog amplifier unit circuit 44.

Insulating substrate 31 is mounted on substrate mounting region 30a, with their surfaces facing each other. The plurality of output pads 43 are bonded to the plurality of output pads 40, respectively, and the plurality of input pads 45 are bonded to the plurality of input pads 41, respectively.

Analog amplifier unit circuit 44 current-amplifies a gradation potential supplied from D/A converter 32 via input pads 41 and 45 to provide the current-amplified gradation potential to corresponding data line DL via output pads 40 and 43. Note that analog amplifier unit circuit 44 also includes an offset cancel circuit for compensating for the offset voltage thereof.

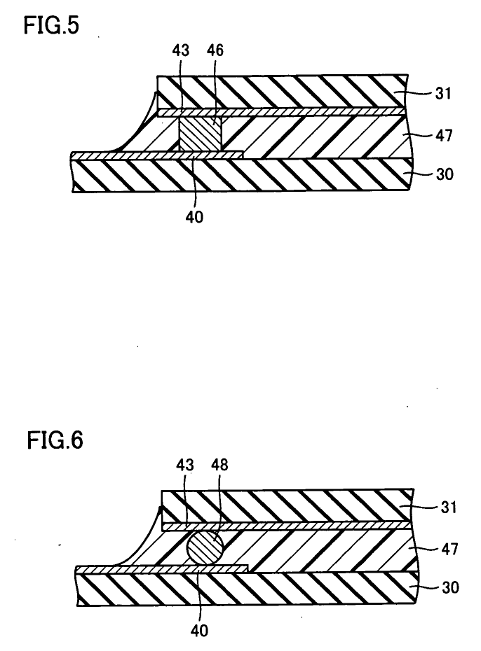

FIG. 5 shows a way of bonding the pads with each other. Insulating substrate 31 is mounted on substrate mounting region 30a of insulating substrate 30, with its circuit-provided surface facing down. Output pad 40 on insulating substrate 30 and output pad 43 on insulating substrate 31 are bonded via a bump (conductive protrusion) 46. Input pads 41 and 45 are bonded similarly. Insulating substrates 30 and 31 are bonded with resin 47. As shown in FIG. 6, pads 40 and 43 may be bonded via a metal grain 48.

In the first embodiment of the present invention, insulating substrate 31 having analog amplifier 14 which is likely to suffer failure formed thereon, and insulating substrate 30 having a circuit portion of the color liquid crystal display except for analog amplifier 14 formed thereon are separately prepared and quality-tested, and only insulating substrate 31 of good quality is mounted on insulating substrate 30 of good quality. This allows yield improvement and cost reduction of the color liquid crystal display compared to the conventional case where the entire color liquid crystal display is formed on a single insulating substrate.

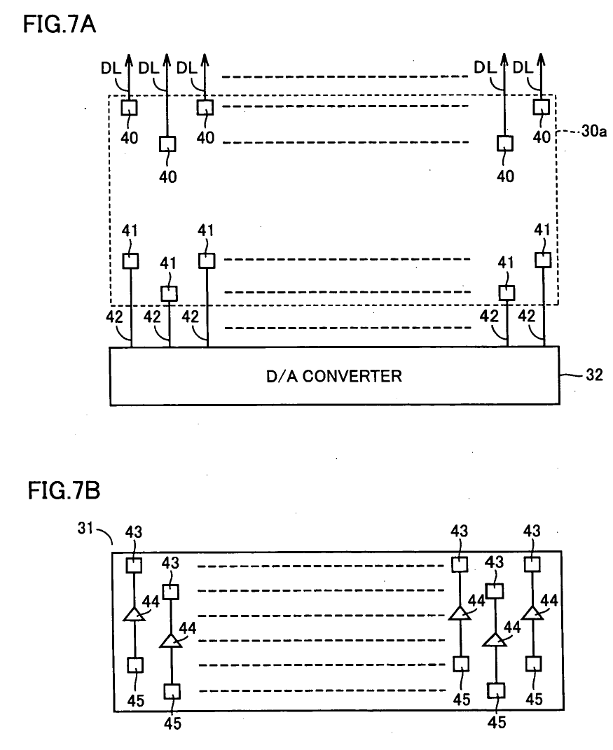

FIGS. 7A and 7B show a modification of the first embodiment of the present invention, and FIGS. 7A and 7B are to be compared with FIGS. 4A and 4B. Referring to FIGS. 7A and 7B, in this modification, the plurality of output pads 40 are alternately arranged on two lines parallel with each other with a predetermined pitch, and output pads 43 corresponding to output pads 40 are similarly arranged in a staggered manner. Furthermore, the plurality of input pads 41 are alternately arranged on two lines parallel with each other with a predetermined pitch, and input pads 45 corresponding to input pads 41 are similarly arranged in a staggered manner. Since this modification enables the pads to be spaced more apart, insulating substrate 31 can more easily be mounted on insulating substrate 30.

Second Embodiment

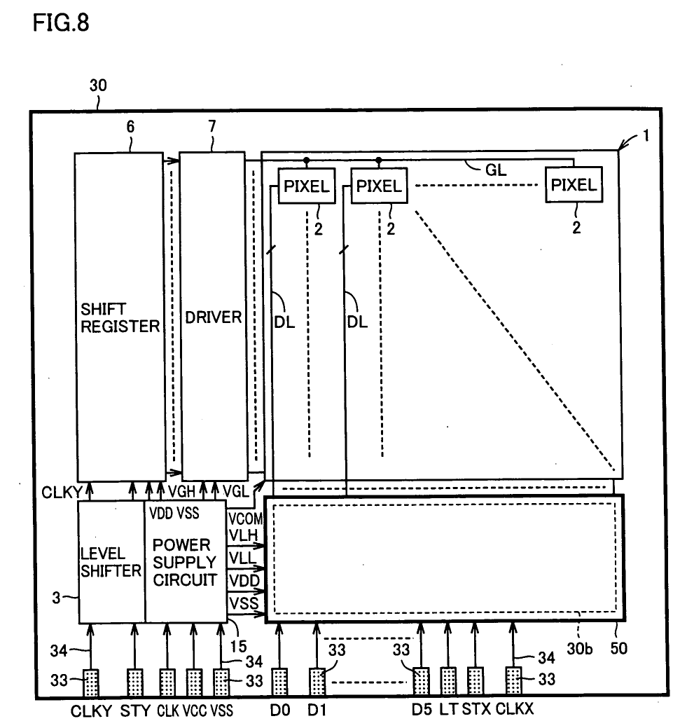

FIG. 8 shows a configuration of a color liquid crystal display according to a second embodiment of the present invention, and is to be compared with FIG. 3. Referring to FIG. 8, in this color liquid crystal display, analog amplifier 14, D/A converter 32 and level shifter 4 are formed on a surface of a single insulating substrate 50, while the remaining circuit portion such as pixel array 1 is formed on the surface of insulating substrate 30. Insulating substrate 50 which has passed the test is mounted on a substrate mounting region 30b of insulating substrate 30 which has passed the test.

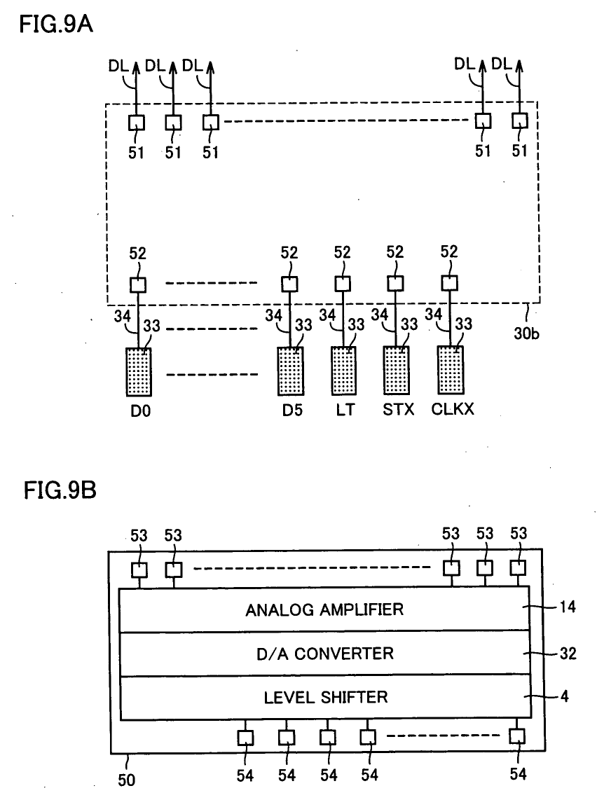

FIG. 9A illustrates substrate mounting region 30b, while FIG. 9B illustrates a surface of insulating substrate 50 (a surface facing the surface of insulating substrate 30). To simplify the drawings and the description, a pad and interconnection for power supply are not shown. Referring to FIGS. 9A and 9B, substrate mounting region 30b has formed therein an output pad 51 provided corresponding to each data line DL and an input pad 52 provided corresponding to each external terminal 33. A plurality of output pads 51 are arranged in line along a lower side of pixel array 1, and each output pad 51 is connected to corresponding data line DL. A plurality of input pads 52 are arranged in line to face a plurality of external terminals 33, and each input pad 52 is connected to corresponding external terminal 33 via aluminum interconnection 34.

On the surface of insulating substrate 50, output pad 53 provided corresponding to each data line DL and input pad 54 provided corresponding to each external terminal 33 are formed. A plurality of output pads 53 are arranged in line along an upper side of insulating substrate 50 and connected to analog amplifier 14. A plurality of input pads 54 are arranged in line along a lower side of insulating substrate 50 and connected to level shifter 4.

Insulating substrate 50 is mounted on substrate mounting region 30b, with their surfaces facing each other. The plurality of output pads 53 are bonded to the plurality of output pads 51, respectively, and the plurality of input pads 54 are bonded to the plurality of input pads 52, respectively.

Level shifter 4, D/A converter 32 and analog amplifier 14 operate in synchronization with start signal STX, clock signal CLKX and latch signal LT provided via three external terminals 33, three input pads 52 and three input pads 54, to provide a gradation potential to a plurality of data lines DL via a plurality of output pads 53 and a plurality of output pads 51 in accordance with image data signals D0-D5 provided via six external terminals 33, six input pads 52 and six input pads 54.

In the second embodiment, insulating substrate 50 having D/A converter 32, level shifter 4 and analog amplifier 14 vulnerable to failure formed thereon, and insulating substrate 30 having the remaining circuit portion of the color liquid crystal display formed thereon are separately prepared and quality-tested, and only insulating substrate 50 of good quality is mounted on insulating substrate 30 of good quality. This allows yield improvement and cost reduction of the color liquid crystal display compared to the conventional case where the entire color liquid crystal display is formed on a single insulating substrate.

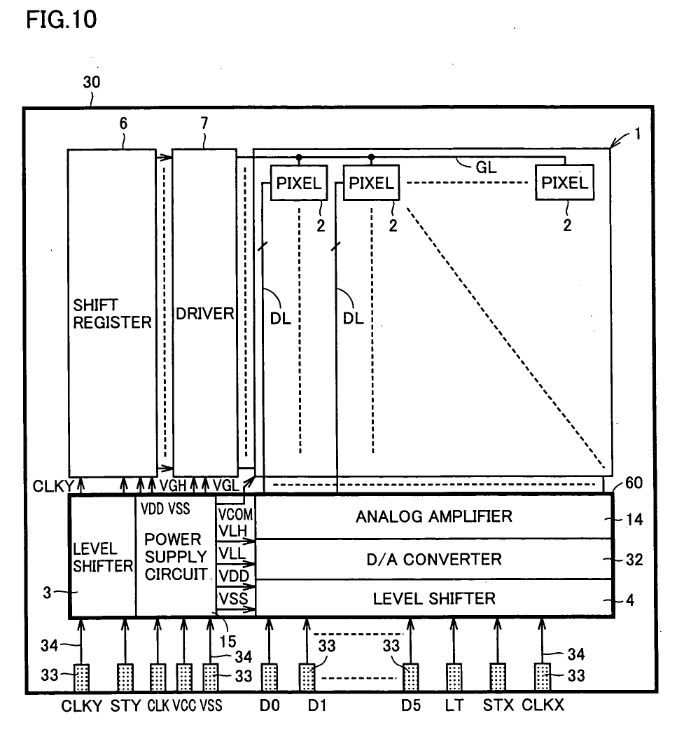

Various modifications are hereinafter described. In a color liquid crystal display shown in FIG. 10, analog amplifier 14, D/A converter 32, level shifters 3 and 4, and power supply circuit 15 are formed on a surface of a single insulating substrate 60, while the remaining circuit portion such as pixel array 1 is formed on the surface of insulating substrate 30. Insulating substrate 60 which has passed the test is mounted on the substrate mounting region of insulating substrate 30 which has passed the test. Since the method of mounting insulating substrate 60 is similar to the method described in conjunction with FIGS. 9A and 9B and the like, the description thereof will not be repeated. This modification can also increase yield of the color liquid crystal display. In addition, if shift register 6 and driver 7 are formed exclusively of TFTs having the same conductivity type (N-type herein) as that of the TFTs included in pixel 2 (see Japanese Patent Laying-Open Nos. 2002-328643 and 9-246936), cost reduction of the device can be achieved.

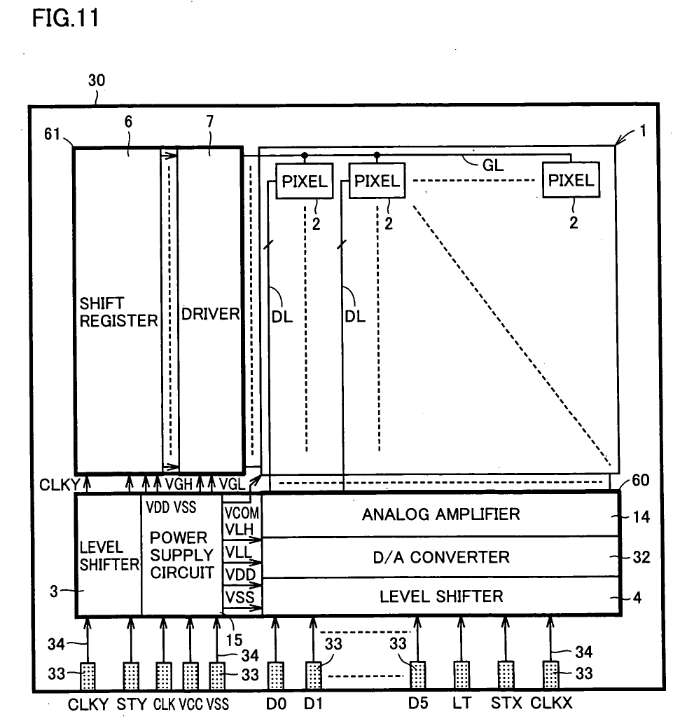

In a color liquid crystal display shown in FIG. 11, analog amplifier 14, D/A converter 32, level shifters 3 and 4, and power supply circuit 15 are formed on the surface of single insulating substrate 60, and shift register 6 and driver 7 are formed on a surface of another insulating substrate 61. The remaining circuit portion such as pixel array 1 is formed on the surface of insulating substrate 30. Insulating substrates 60 and 61 which have passed the test are mounted on the substrate mounting region of insulating substrate 30 which has passed the test. The present modification can also increase yield of the color liquid crystal display. Note that the pixels can be formed of amorphous silicon in this modification.

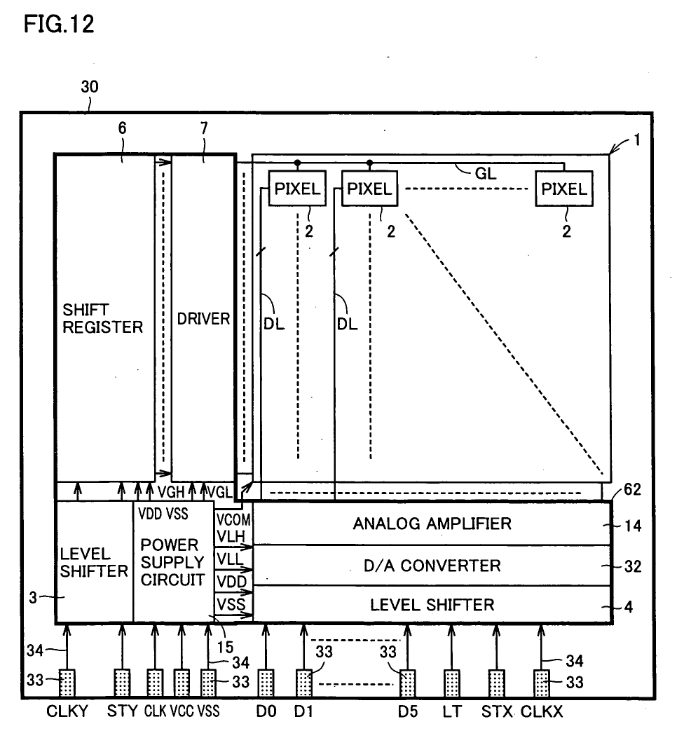

In a color liquid crystal display shown in FIG. 12, analog amplifier 14, D/A converter 32, level shifters 3 and 4, power supply circuit 15, shift register 6 and driver 7 are formed on a surface of a single insulating substrate 62, while the remaining circuit portion such as pixel array 1 is formed on the surface of insulating substrate 30. Insulating substrate 62 which has passed the test is mounted on the substrate mounting region of insulating substrate 30 which has passed the test. The present modification can also increase yield of the color liquid crystal display. Note that the pixels can also be formed of amorphous silicon in this modification.

Third Embodiment

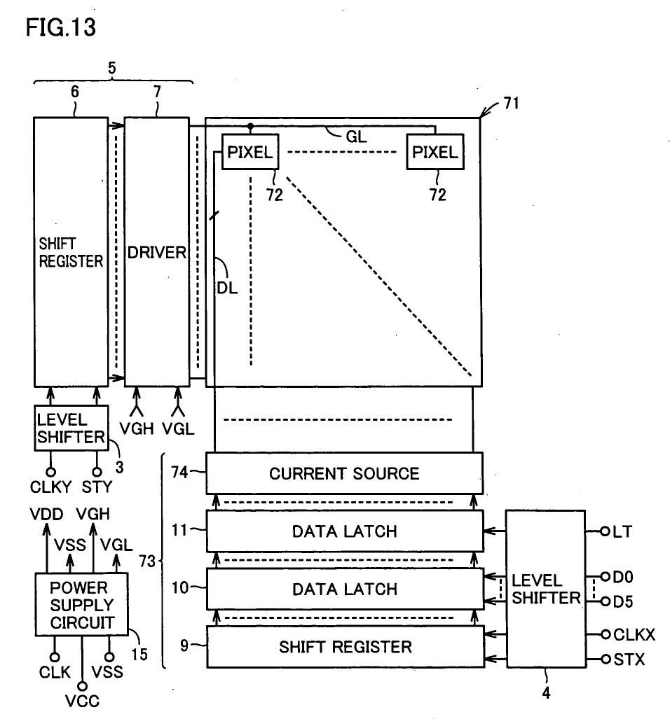

FIG. 13 shows a configuration of a color image display according to a third embodiment of the present invention, and is to be compared with FIG. 1. Referring to FIG. 13, this color image display differs from the color liquid crystal display shown in FIG. 1 in that a pixel array 71 and a horizontal scan circuit 73 replace pixel array 1 and horizontal scan circuit 8, respectively.

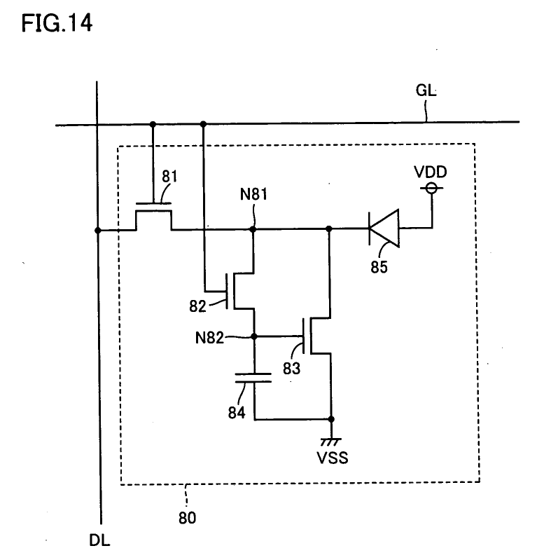

In pixel array 71, a color pixel 72 replaces color pixel 2 of pixel array 1. Color pixel 72 includes three sub-pixels 80 for R, G and B. As shown in FIG. 14, sub-pixel 80 includes N-type TFTs 81-83, a capacitor 84, and an electroluminescence (EL) element 85. EL element 85 and N-type TFT 83 are connected in series between a line of power supply potential VDD and a line of ground potential VSS. N-type TFT 81 is connected between data line DL and the drain of N-type TFT 83 (a node N81), while N-type TFT 82 is connected between node N81 and the gate of N-type TFT 83 (a node N82). Both of the gates of N-type TFTs 81 and 82 are connected to gate line GL. Capacitor 84 is connected between node N82 and the line of ground potential VS S.

When gate line GL is raised to an “H” level of a selected level, N-type TFTs 81 and 82 are rendered conductive. When a current at the level corresponding to image data signals D0-D5 flows through data line DL, the current flows through the line of ground potential VSS via N-type TFTs 81 and 83 so as to charge capacitor 84 to the gate potential of N-type TFT 83. When gate line GL falls to an “L” level of a non-selected level, N-type TFTs 81 and 82 become non-conductive, and a current at the level corresponding to the charged potential of capacitor 84 flows through EL element 85 and N-type TFT 83. EL element 85 emits light at the light intensity corresponding to the current.

Returning to FIG. 13, in horizontal scan circuit 73, a current source 74 replaces ladder resistance 12, multiplexer 13 and analog amplifier 14 in horizontal scan circuit 8 shown in FIG. 1. Current source 74 converts data signals D0-D5 supplied from data latch 11 to an analog current for each data line DL, and provides the analog current to data line DL.

In the third embodiment, as in the first and second embodiments, a first insulating substrate having at least current source 74 which is likely to suffer failure formed thereon, and a second insulating substrate having at least pixel array 71 formed thereon are separately prepared and quality-tested, and only the first insulating substrate of good quality is mounted on the second insulating substrate of good quality. This allows yield improvement and cost reduction of the color image display.

In the first to third embodiments above, the image display using liquid crystal cell 22 and EL element 85 has been explained. However, the present invention may also be applied to an image display using any other type of an optical element.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image display comprising:
a pixel array including a plurality of pixel display circuits arranged in a plurality of rows and a plurality of columns and each displaying a pixel with a gradation corresponding to a pixel potential, a plurality of gate lines provided corresponding to said plurality of rows, respectively, and a plurality of data lines provided corresponding to said plurality of columns, respectively;
a vertical scan circuit sequentially selecting said plurality of gate lines, one for each predetermined period of time, and activating each of the pixel display circuits corresponding to the selected gate line;
a horizontal scan circuit providing, while said vertical scan circuit selects one gate line, the pixel potential to each of the activated pixel display circuits through said plurality of data lines;
an insulating substrate having at least said pixel array formed on a surface thereof, and
at least one sub-insulating substrate mounted on the surface of said substrate; wherein
said vertical scan circuit and said horizontal scan circuit are located on the surface of said insulating substrate and a surface of said at least one sub-insulating substrate, separately, and
a circuit portion of said horizontal scan circuit connected to at least said plurality of data lines is formed on the surface of said at least one sub-insulating substrate.

2. The image display according to claim 1, wherein
said vertical scan circuit is formed on the surface of said insulating substrate, and
said horizontal scan circuit is formed on the surface of one said sub-insulating substrate.

3. The image display according to claim 1, wherein
said vertical scan circuit is formed on the surface of one said sub-insulating substrate, and
said horizontal scan circuit is formed on the surface of another said sub-insulating substrate.

4. The image display according to claim 1, wherein said vertical scan circuit and said horizontal scan circuit are formed on the surface of one said sub-insulating substrate.

5. The image display according to claim 1, wherein
said pixel display circuit includes a liquid crystal cell,
said horizontal scan circuit includes
a pixel potential generating circuit generating a plurality of pixel potentials corresponding to said plurality of data lines, respectively, in accordance with an image data signal, and
an amplifier circuit amplifying said plurality of pixel potentials generated in said pixel potential generating circuit to provide the amplified pixel potentials to said plurality of data lines, respectively, and
said amplifier circuit is formed on the surface of one said sub-insulating substrate.

6. The image display according to claim 1, wherein
said pixel display circuit includes an electroluminescence element,
said horizontal scan circuit includes a current source supplying a current to each said data line in accordance with the image data signal and generating said pixel potential on each said data line, and
said current source is formed on the surface of one said sub-insulating substrate.

7. The image display according to claim 1, further comprising a power supply circuit generating an internal power supply potential based on an external power supply potential, wherein
said power supply circuit is formed on the surface of the sub-insulating substrate on which the circuit portion of said horizontal scan circuit connected to at least said plurality of data lines is formed.

8. The image display according to claim 1, wherein said insulating substrate and said at least one sub-insulating substrate are formed of a same insulating material.

9. The image display according to claim 1, wherein said at least one sub-insulating substrate is formed of glass.

10. The image display according to claim 1, wherein the circuit on the surface of said at least one sub-insulating substrate includes a thin film transistor.

11. The image display according to claim 10, wherein the circuit on the surface of said insulating substrate includes a thin film transistor, and
the thin film transistor on the surface of said at least one sub-insulating substrate and the thin film transistor on the surface of said insulating substrate are formed of a same semiconductor material.
